(19) United States
(12) Patent Application Publication
(10) Pub. No.: US 2005/0273678 A1
(43) Pub. Date: Dec. 8, 2005

(54) Test apparatus for testing an integrated circuit

(75) Inventors: Stefan Dietrich, Turkenfeld (DE); Arti Prasad-Roth, Cary, NC (US); Armin Rettenberger, Munchen (DE); Peter Schroegmeier, Munchen (DE)

Correspondence Address: MORRISON & FOERSTER LLP, 1650 TYSONS BOULEVARD, SUITE 300, MCLEAN, VA, 22102, US

(73) Assignee: INFINEON TECHNOLOGIES AG, Munchen (DE)

(21) Appl. No.: 11/112,000

(22) Filed: Apr. 22, 2005

(30) Foreign Application Priority Data
Apr. 23, 2004 (DE) 10 2004 020 030.0

(51) Int. Cl. G06F 19/00

(52) U.S. Cl. 714/718

(57) ABSTRACT

Test apparatus for testing an integrated circuit The invention relates to a test apparatus for testing an integrated circuit, particularly a DDR semiconductor memory, having at least one data connection for inputting at least one data signal, at least one DQS control connection for inputting at least one unaltered-frequency DQS signal, a device for phase shifting which is designed to take the unaltered-frequency DQS signal and produce a phase-shifted DQS signal, and a combinational logic device which is connected downstream of the device and which logically combines the unaltered-frequency DQS signal with the phase-shifted DQS signal to produce an altered-frequency DQS signal which has a frequency that is increased compared with the frequency of the unaltered-frequency DQS signal and which is provided for latching the data signals or as a clock signal. The invention also relates to a method for operating a test apparatus of this type.

### CLAIM FOR PRIORITY

This application claims the benefit of priority to German Application No. 10 2004 020 030.0, filed Apr. 23, 2004, the contents of which are hereby incorporated by reference in its entirety.

### TECHNICAL FIELD OF THE INVENTION

The invention relates to a test apparatus for testing an integrated circuit, particularly a DDR semiconductor memory.

### BACKGROUND OF THE INVENTION

In modern computer and software applications, there is an increasing need to process ever greater volumes of data in ever shorter times. The data are stored using large-scale-integrated memories, such as a DRAM memory. Such semiconductor memories, particularly dynamic read/write memories such as a DRAM memory, are produced in the widest variety of embodiments and variants, the individual embodiments differing from one another essentially in terms of their operating behavior. To meet the aforementioned need for ever greater speed when processing data, it is now necessary to write these data to the semiconductor memory and read them therefrom at a corresponding speed.

This can firstly be done using a higher operating frequency for reading and writing the data from and to the semiconductor memory.

Another option is to use semiconductor memories designed specifically for high data rates. A typical example of such a semiconductor memory is the “DDR-DRAM memory”, where DDR stands for “Double Data Rate”. Whereas, in conventional semiconductor memories, read and write operations are performed only on the rising or falling edge of a clock signal, in the aforementioned DDR semiconductor memories data are read from the semiconductor memory and written back to the memory both on the rising and falling edges of the clock signal. These semiconductor memories are thus distinguished by twice the data rate.

Such semiconductor memories use a “data strobe signal”—subsequently called DQS signal for short—in order to synchronize the data which are read from the semiconductor memory and which need to be written to it. This DQS signal has a similar structure to the data signal and therefore uses data lines in the data path. The timing between the DQS signal and the data signal (I/O signal) is clearly defined in the specification of a semiconductor memory. For this reason, this timing needs to be measured in order to be able to prove that it is still within the admissible range prescribed by the specification.

The read operation is uncritical in this instance, since when a semiconductor memory is read both the data signal and the DQS signal are generated by the semiconductor memory itself. By contrast, when writing (write operation) to the semiconductor memory, both the DQS signal and the data signal containing the data which need to be written to the semiconductor memory are generated externally and are input into the semiconductor memory. When such a write operation is tested, the generation and input of these signals, that is to say of the DQS signal and of the data signal, are the limiting factor. To be able to test a DDR semiconductor memory designed for an operating frequency of 500 MHz (1 Gbit/s in DDR mode) properly, for example, there need to be DQS signals at the same frequency in the DDR semiconductor memory. These DQS signals need to be provided by the test unit in question.

In previous semiconductor memories, the test units in question were more powerful than the semiconductor memories to be tested. However, modern semiconductor memories, particularly the aforementioned DDR semiconductor memories, are very much faster than the aforementioned conventional test units. This is because the DDR semiconductor memories mentioned at the outset can be operated at a double data rate and hence internally at a double frequency. By way of example, future DDR semiconductor memories, such as third-generation DDR semiconductor memories, will be operated at a frequency of between 800-900 MHz. Currently available test arrangements for testing semiconductor memories are designed only for a maximum frequency of approximately 500 MHz, however.

In this situation, “high-performance semiconductor memories”, such as graphics DRAM memories, reduced-latency DRAM memories etc., which are operated at a very high frequency, can no longer be tested (or can be tested only incompletely) by today's test units. This immediately leads to a situation in which relatively expensive memory products are sold without their being adequately tested. It is thus not possible to establish definitively whether or not they are now faulty, however. A semiconductor memory which is faulty or not fully functional would not be accepted by buyers of such expensive, “high-end” products, however.

So as now to be able to test these semiconductor memories nevertheless, it would therefore be necessary to develop test units designed specifically for testing the semiconductor memories. The development and provision of test units designed specifically for testing such DRAM memory products therefore becomes extraordinarily cost-intensive, which likewise raises the cost of the corresponding semiconductor memories to be tested. However, this development is contrary particularly to the trend inherent in DRAM memory development for providing ever less expensive solutions and hence ever less expensive DRAM semiconductor memories.

German Laid-Open Specification DE 102 00 898 A1 describes an arrangement and a method in which the read path of a semiconductor memory is tested. For the purpose of testing, the available system clock is doubled internally. Hence, in semiconductor memories whose operating frequency in normal operation is above a maximum frequency for a test unit used for a test mode, an opportunity is created for testing the full frequency range of the semiconductor memory's read path.

However, the solution described in DE 102 00 898 A1 cannot be used to test a semiconductor memory's write path as well, since writing in the semiconductor memory also requires that the corresponding DQS signal and, in addition, the data signal be tested at a double frequency. In this case, although the solution described in DE 102 00 898 A1 would allow the read path to be tested at a higher frequency, the write path would remain bypassed and hence would remain untested.

This is a condition which understandably needs to be avoided.

### SUMMARY OF THE INVENTION

The invention relates generally to the testing of integrated circuits which are operated at a very high frequency. Although they can be applied to any integrated circuits which need to be tested using a suitable tester arrangement, the present invention and the problems which underlie it are explained below with reference to “DDR semiconductor memories”.

The present invention provides a test apparatus which can be used to test semiconductor memories which are operated at a higher frequency than the maximum frequency of the test apparatus. In particular, a better test option for the semiconductor memory's read path is intended to be provided.

In several embodiments of the invention, there are:
a test apparatus for testing an integrated circuit, particularly a DDR semiconductor memory, having at least one data connection for inputting at least one data signal, having at least one DQS control connection for inputting at least one unaltered-frequency DQS signal, having a device for phase shifting which is designed to take the unaltered-frequency DQS signal and produce a phase-shifted DQS signal, and having a combinational logic device which is connected downstream of the device and which logically combines the unaltered-frequency DQS signal with the phase-shifted DQS signal to produce an altered-frequency DQS signal which has a frequency that is increased compared with the frequency of the unaltered-frequency DQS signal and which is provided for latching the data signals or as a clock signal.
a method for operating a test apparatus based on the invention having a first mode of operation, in which the test apparatus is operated using the unaltered-frequency DQS signal in order to latch the data signals, and having a second mode of operation, in which the test apparatus is operated using the altered-frequency DQS signal at a frequency which is higher compared with the frequency of the unaltered-frequency DQS signal in order to latch the data signals.

The present invention provides testing a write path within the test apparatus by increasing the frequency of the DQS signal which is available anyway. The available DQS signal is also called the unaltered-frequency DQS signal, since it has a prescribed frequency. The clock rate of the DQS signal is increased very easily by phase-shifting the available DQS signal. This produces a DQS signal and an associated phase-shifted DQS signal, which are input into the input side of a combinational logic circuit. The signal produced at the output of the combinational logic circuit thus corresponds to a DQS signal at an increased clock frequency.

In this way, it is advantageously possible to use a conventional test apparatus operated at low frequency to test a semiconductor memory which is operated at a very much higher frequency, particularly at a frequency which is twice higher. The advantages are obvious in this case:

In particular, testing the read path in modern semiconductor memories, such as in the DDR semiconductor memory, which are operated at a very high frequency does not necessarily require the provision of cost-intensive test units provided specifically for testing the semiconductor memories. In this context, it is sufficient to use the previously used, conventional test units for testing, provided that they have been appropriately extended by a device for phase shifting and by a combinational logic circuit.

The increased-frequency DQS signal obtained in this manner can thus be used for latching the data in the write path and hence for testing the write path. To do this, the data are written to the semiconductor memory on every rising and falling edge of the higher-frequency DQS signal obtained in this manner.

Advantageously, the combinational logic device is in the form of an XOR gate. The functionality of the combinational logic circuit may naturally also be provided by an XNOR gate. However, it would also be conceivable to use any other device which has a functionality corresponding to that of an XOR gate or XNOR gate, for example an appropriate logic circuit or a program-controlled device.

In one advantageous embodiment, the DQS signal phase-shifted through 90° is obtained by phase-shifting the original DQS signal. When the 90°-phase-shifted DQS signal obtained in this manner is logically combined with the original DQS signal using an XOR gate, it is thus possible to provide a DQS signal at twice the clock frequency, in which the high phases and low phases of this double DQS signal are of equal length. In an alternative refinement, a DQS signal and an associated inverted DQS signal are provided, the 90°-phase-shifted DQS signal being derived from one of these two DQS signals.

The inventive test apparatus has a latch device for latching the data signals which is connected to the data connections via the data path and is connected to the DQS control connections via a DQS control path.

Advantageously, the DQS control path has a first path with an unaltered-frequency DQS signal and a second path with a DQS signal which has a higher frequency, particularly twice the frequency, compared with the unaltered-frequency DQS signal. Which of these paths is used and hence which of these DQS signals is used to latch the data in the data path can be set using a multiplexer device whose output is connected downstream of the two paths. In this way, it is possible to use a conventional test apparatus, on the one hand, for operating conventional semiconductor memories which can be operated at low frequency, and additionally it is also possible to extend the functionality of this test apparatus by being able to provide a DQS signal, when selecting the second path, which (signal) can also be used to test the data paths, particularly the write paths of modern, higher-frequency semiconductor memories. To this end, the inventive test apparatus advantageously has a connection for setting a mode of operation. This connection, which is connected to a control connection on the multiplexer, can be used to set the mode of operation of the test apparatus by selecting the first or second path.

The device for increasing the frequency of the DQS signal, in this case particularly the device for phase shifting, the receiver, the XOR gate and the multiplexer typically have a gate transit time which is associated with these devices. The higher-frequency DQS signal therefore has a corresponding time delay in comparison with the unaltered-frequency DQS signal at the input. The result of this time delay is that the DQS signal in the DQS control path is delayed to a greater or lesser extent compared with the corresponding data signal in the data path. In one particularly advantageous development, the data path therefore contains a compensating device which takes account of this time delay in the DQS control path and which thus delays the data signal in the data path using an appropriate time delay. In one very advantageous refinement, the data path therefore advantageously contains the same circuit parts or at least circuit parts having the same gate transit times as are responsible for the time delay in the DQS control path.

Typically, the compensating device has at least one further XOR gate and/or a further multiplexer which are in a form such that the gate transit times thereof are based on the corresponding gate transit times of the XOR gate and/or of the multiplexer in the DQS control path. This makes it possible to ensure that the data path also contains a time delay which is identical to or is at least largely the same as that in the DQS control path.

In one typical and also advantageous refinement, the data connections are in the form of write data connections. These write data connections can be used to input write data signals (WRITE) which are to be written to a semiconductor memory into the test apparatus. The inventive test apparatus is thus designed for testing the write path of a semiconductor memory, particularly of a DDR semiconductor memory.

### BRIEF DESCRIPTION OF THE DRAWINGS

The invention is explained in more detail below using the exemplary embodiments which are specified in the figures below, in which:

FIG. 1 uses a block diagram to show the basic design of a test unit based on the invention.

FIG. 2 shows a first exemplary embodiment of a device for providing a DQS signal at double frequency.

FIG. 3 shows a second exemplary embodiment of a device for providing a DQS signal at double frequency.

FIG. 4 uses a block diagram to show a detailed design for a test unit based on the invention.

FIG. 5 shows a flowchart to illustrate the latching of the write data using a DQS signal at double frequency which has been produced in line with the invention.

In all figures of the drawings, elements and signals which are the same or have the same function have been provided with the same reference symbols—unless stated otherwise.

### DETAILED DESCRIPTION OF THE DRAWINGS

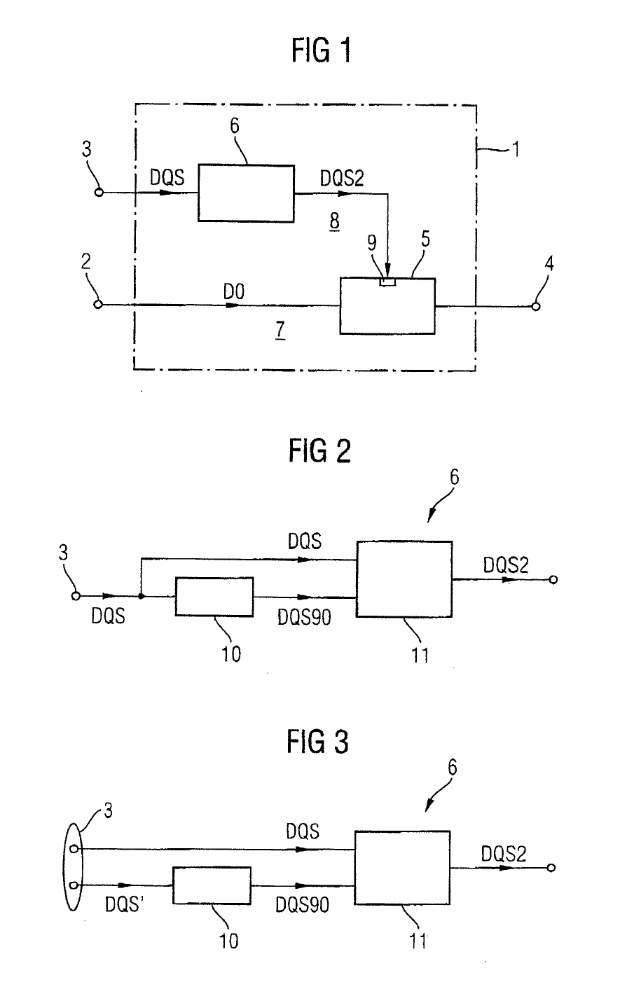

FIG. 1 uses a block diagram to show the basic design of a test unit based on the invention. In this case, the test unit is denoted by reference symbol 1. The test unit 1 has data inputs 2, DQS inputs 3 and a data output 4. The data inputs 2 can be used to input data signals D0 and the DQS inputs 3 can be used to input DQS signals DQS into the test unit 1.

The test unit 1 has a latch device 5, for example a shift register. The latch device 5 is arranged between the data inputs 2 and the data output 4, so that this latch device 5 has data signals D0 supplied to its input. The DQS signals DQS2, whose frequency is increased, in the present case doubled, compared with the DQS signal DQS which is input on the input side, are used to latch the data signals D0. To produce the DQS signal DQS2 at double frequency, a device 6 for increasing the clock frequency is provided. The design and mode of operation of this device 6 are described below with reference to FIGS. 2 and 3.

In this case, FIG. 2 shows a first exemplary embodiment of the device 6 for providing a DQS signal DQS2 at double frequency. In this context, the device 6 has a circuit for phase shifting 10 and an exclusive OR circuit 11 connected downstream of this circuit 10. The input side of the circuit 10 for phase shifting is supplied with the DQS signal DQS. In the present exemplary embodiment, the circuit 10 is designed to shift the phase of the DQS signal DQS which is input on the input side. The 90°-phase-shifted DQS signal DQS90 obtained in this manner is input into the downstream XOR circuit 11 together with the original DQS signal DQS. From this input, the XOR circuit 11 produces a DQS signal DQS2 which has twice the frequency of the DQS signal DQS which is at the input. The corresponding timing of the various DQS signals DQS, DQS90, DQS2 is shown in FIG. 5.

FIG. 3 shows a second exemplary embodiment of the device 6 for providing a DQS signal at double frequency. Unlike in the exemplary embodiment in FIG. 2, the circuit 6 has both the DQS signal DQS and the associated inverted DQS signal DQS′ supplied to its input. In this case, one of these two signals, in the present exemplary embodiment the inverted DQS signal DQS′, is phase-shifted through 90° in the circuit 10.

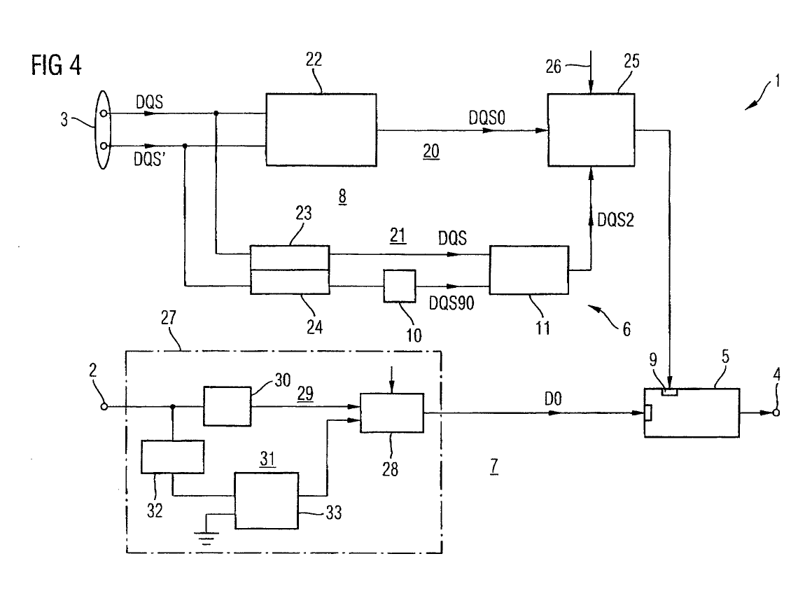

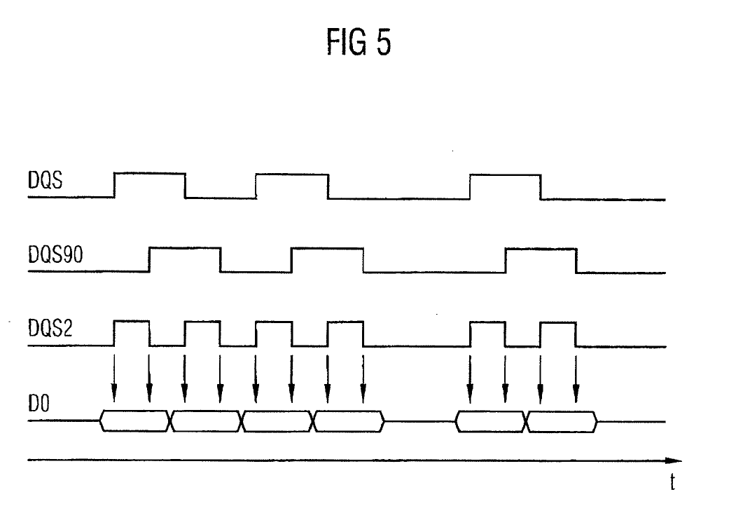

FIG. 4 uses a block diagram to show a detailed design for a test unit 1 based on the invention. In this case, the test unit 1 is based on the refinement of the circuit 6 in FIG. 3, in which the DQS signal DQS and the associated inverted DQS signal DQS′ are input on the input side.

Unlike in the exemplary embodiment in FIG. 1, the test unit 1 has a first and a second path 20, 21 in the DQS control path 8, said first and second paths being arranged in parallel with one another and thus having their inputs connected to the inputs 3 and having their outputs connected to a control connection 9 on the latch device 5. The first path 20 has a differential receiver 22 which is connected to the inputs 3 and which is designed to produce a DQS signal DQS0 at single frequency at its output from the two DQS signals DQS, DQS′ in order to actuate the latch device 5.

The second path 21 contains the inventive circuit 6, which likewise has a receiver circuit connected upstream of it, in the present case a respective receiver 23, 24 for each input on the circuit 6. The circuit 6 and hence the second path 21 are designed to provide a DQS signal DQS2 at double frequency for actuating the latch device 5.

Which path 20, 21 and hence which DQS signal DQS2, DQS are used to actuate the latch device 5 can be selected using a multiplexer circuit 25. The multiplexer circuit 25 is actuated by means of a suitable control signal 26 which can be set externally, for example by the user of the test unit 1.

Between the data inputs 2 and the input of the latch device 5, the data path 7 contains a delay device 27 which takes account of a delay in the DQS control path 9. The delay device 27 produces a delay which corresponds to the delay in the DQS control path 8. In this way, the data signals D0 supplied to the latch device 5 are likewise delayed. For this purpose, the delay device 27 likewise has those circuit parts which are responsible for delaying the DQS signals DQS, DQS′ in the DQS control path 8. In particular, the delay device 27 also has a multiplexer circuit 28. In addition, the delay circuit 27 maps the corresponding paths 20, 21 in the DQS control path 8 and in so doing the delay-related elements contained therein, in particular. For this reason, a first path 29 in the delay circuit 27 contains a receiver 30, and a second path 31 contains a receiver 32 and also an XOR gate 33. The receivers 30, 32, the multiplexer 28 and the XOR gate 33 typically have the same transit times (in terms of their gate transit times) as the corresponding elements 11, 22-25 in the DQS control path 8.

FIG. 5 shows a flowchart to illustrate the latch process for testing write access using a DQS signal DQS2 at double frequency which has been produced in line with the invention. The DQS signal DQS2 at double frequency is in this case derived from the DQS signals DQS, DQS90, which are phase-shifted with respect to one another. The resultant, more or less doubled DQS signal DQS2 thus has approximately the same frequency as the data signal D0, which contains write data for a semiconductor memory. In this way, the data D0 can be latched using the rising and falling edges of the DQS signal DQS2 at double frequency.

Although the present invention has been described above using a preferred exemplary embodiment, it is not limited thereto but rather can be modified in a wide variety of ways.

The invention has also been described by way of example for the use of a semiconductor memory, particularly one in the form of a DDR semiconductor memory. The invention is not limited exclusively thereto, however, but rather can be used to advantage in any semiconductor memory arrangements. The invention is also not necessarily limited to use for testing the write path of a semiconductor memory, even though this application is particularly advantageous.

In the exemplary embodiments above, the DQS signal has also been respectively phase-shifted through 90°. It would naturally also be conceivable in this context to have any other phase shift, even though a 90° phase shift is particularly advantageous for producing a DQS signal at double frequency. It goes without saying that by virtue of appropriate successive connection of the inventive circuit for increasing the frequency of DQS signals it is also possible to provide DQS signals at more than twice the frequency, for example four times, eight times etc., the frequency.

### LIST OF REFERENCE SYMBOLS

1 test unit, test apparatus
2 data inputs
3 DQS inputs
4 data outputs
5 latch device, shift register
6 circuit for producing DQS signals at an increased frequency
7 data path, write path
8 DQS control path
9 control connection
10 device for phase shifting
11 exclusive-or circuit, XOR gate, XNOR gate
20 first path
21 second path
22 differential receiver
23 receiver
24 receiver
25 multiplexer device
26 control signal
27 delay circuit
28 multiplexer
29 first path
30 receiver
31 second path
32 receiver
33 XOR gate
D0 data signal
DQS DQS control signal
DQS0 DQS control signal
DQS2 DQS control signal at double frequency
DQS90 90°-Phase-shifted DQS control signal
DQS′ Inverted DQS control signal

1. A test apparatus for testing an integrated circuit, comprising:
at least one data connection for inputting at least one data signal;
at least one DQS control connection for inputting at least one unaltered-frequency DQS signal;
a device for phase shifting which is designed to take the unaltered-frequency DQS signal and produce a phase-shifted DQS signal; and
a combinational logic device which is connected downstream of the device and which logically combines the unaltered-frequency DQS signal with the phase-shifted DQS signal to produce an altered-frequency DQS signal which has a frequency that is increased compared with the frequency of the unaltered-frequency DQS signal and which is provided for latching the data signals or as a clock signal.

2. The test apparatus according to claim 1, wherein the combinational logic device is in a form of an XOR gate or in a form of an XNOR gate.

3. The test apparatus according to claim 1, wherein the device for phase shifting is designed to provide a 90° phase shift in the unaltered-frequency DQS signal or in an inverted DQS signal derived therefrom.

4. The test apparatus according to claim 1, wherein the altered-frequency DQS signal has a frequency which is twice the frequency of the unaltered-frequency DQS signal.

5. The test apparatus according to claim 1, wherein a latch device for latching the data signals is provided which is connected to the data connections via a data path and which is connected to the DQS control connections via a DQS control path.

6. The test apparatus according to claim 5, wherein the DQS control path has a first path with the unaltered-frequency DQS signal and a second path with the altered-frequency DQS signal.

7. The test apparatus according to claim 6, wherein the DQS control path includes a multiplexer whose output is connected downstream of the first and second paths and which can be used to select a respective one of these two paths.

8. The test apparatus according to claim 7, wherein the test apparatus has a connection for setting a mode of operation, the connection being connected to a control connection on the multiplexer and configured to be used to set a mode of operation of the test apparatus by selecting the first or second path.

9. The test apparatus according to claim 5, wherein a compensating device is provided which is arranged in the data path and which delays the data signal using a time delay which corresponds to the time delay which is obtained from producing the altered-frequency DQS signal in the DQS control path.

10. The test apparatus according to claim 9, wherein the compensating device has at least one further XOR gate and/or a further multiplexer which are in a form such that a gate transit times thereof are based on a corresponding gate transit times of the XOR gate and/or of the multiplexer in the DQS control path.

11. The test apparatus according to claim 1, wherein the data connections are in the form of write data connections which can be used to input write data signals which are configured to be written to a semiconductor memory.

12. A method for operating a test apparatus, comprising:
providing a first mode of operation, in which the test apparatus is operated using an unaltered-frequency DQS signal to latch data signals; and
providing a second mode of operation, in which the test apparatus is operated using the altered-frequency DQS signal at a frequency which is higher compared with the frequency of the unaltered-frequency DQS signal to latch the data signals.

13. The method according to claim 12, wherein the data signals are delayed using a delay which is based on a delay for providing the unaltered-frequency DQS signal or the altered-frequency DQS signal in the DQS control path.
